(19) United States
(12) Patent Application Publication
(10) Pub. No.: US 2025/0172421 A1
(43) Pub. Date: May 29, 2025

(54) ULTRASONIC FLOW METER WITH INTEGRATED FLOW AND LEAK DETECTION

(71) Applicant: Neptune Technology Group Inc., Tallassee, AL (US)

(72) Inventor: David Ralph Hamilton, Auburn, AL (US)

(21) Appl. No.: 18/937,125

(22) Filed: Nov. 5, 2024

Related U.S. Application Data
(60) Provisional application No. 63/603,212, filed on Nov. 28, 2023.

(51) Int. Cl. G01F 1/66; G01F 1/667; G01M 3/24; G01M 3/28

(52) U.S. Cl. CPC G01F 1/662; G01F 1/666; G01F 1/667; G01M 3/243; G01M 3/2807

(57) ABSTRACT

A device and a method are described in which an integrated flow and leak detection service is provided. A meter, such as a flow meter, or another apparatus may include a detection circuit. The detection circuit includes a signal chain that operates in a leak detection configuration and a flow measurement configuration. The signal chain may detect the presence or absence of a leak or other acoustic anomalies, and provide localization information when operating in the leak detection configuration. The signal chain may provide flow measurement information when operating in the flow measurement configuration.

### CROSS-REFERENCE TO RELATED APPLICATION

The present application claims priority to U.S. Provisional Patent Application No. 63/603,212 filed on Nov. 28, 2023, the entirety of which is hereby incorporated by reference herein.

### BACKGROUND

Utility companies and other entities operate distribution systems for various resources (e.g., water, gas, electricity, chemicals, etc.) to deliver these resources to customers connected to the distribution systems. A meter may be used at each point where the resource is removed and/or provided from the distribution system to a customer to measure usage. Each meter includes or is coupled to a radio transmitter that has an integral or external antenna. Many metering systems use wireless communications to report meter readings to a backend system via a communication network.

### BRIEF DESCRIPTION OF THE DRAWINGS

FIG. 1 is a diagram illustrating an exemplary embodiment of a meter that includes an exemplary embodiment of an integrated flow and leak detection service;

FIG. 2 is a diagram illustrating another exemplary embodiment a meter that includes an exemplary embodiment of the integrated flow and leak detection service;

FIG. 3A is a diagram illustrating an exemplary embodiment of a detector;

FIG. 3B is a diagram illustrating another exemplary embodiment of the detector;

FIG. 3C is a diagram illustrating yet another exemplary embodiment of the detector;

FIG. 4 is a diagram illustrating exemplary components of a meter that provides an exemplary embodiment of the integrated flow and leak detection service; and

FIGS. 5A and 5B are diagrams illustrating an exemplary process of an exemplary embodiment of the integrated flow and leak detection service.

### DETAILED DESCRIPTION

The following detailed description refers to the accompanying drawings. The same reference numbers in different drawings may identify the same or similar elements. Also, the following detailed description does not limit the invention.

Meters that measure usage of a resource, such as a utility resource (e.g., water, gas, electricity, etc.) or another type of resource (e.g., chemical, etc.) are widely used. Further, meters have been combined with electronic components to facilitate communication between the meters and backend systems via a network. For example, a meter interface unit (MIU) may include a transmitter that is configured to wirelessly transmit usage information and other types of information (e.g., leak information, reverse flow detection, etc.). The MIU may also include a receiver that is configured to wirelessly receive information and commands. The meter and the MIU may be a part of an automated meter reading (AMR) system, such as an AMR system associated with a water utility company, an advanced metering system (AMS), an advanced meter infrastructure (AMI), or another type of architecture associated with a utility company or another entity.

Among the many features of the meter, flow and leak detection may be aspects of the operation of the meter. The meter may include dedicated logic (e.g., transducer, circuitry, etc.) that enables the meter to detect flow. For example, flow detection of a resource, such as water, may relate to various characteristics, such as direction of flow and the flow rate of the flow. The meter may also include dedicated logic (e.g., a sensor, circuitry) that enables measurement of noise indicative of a leak. For example, leak detection may relate to identifying the presence of a leak and potentially the general location of the leak.

The design for flow detection and leak detection of a meter includes various considerations including cost, power consumption, and selection of components of a detection circuit that enables robust flow and leak detection in an efficient and optimal manner. Given the distinctive features between flow detection and leak detection, a unitary receiving and processing chain that provides flow and leak detection may minimize cost and optimize use of components or circuitry directed to flow and leak detection.

According to exemplary embodiments, an integrated flow and leak detection service is described. According to an exemplary embodiment, a meter provides the integrated flow and leak detection service. For example, a water meter or another type of flow meter may provide the integrated flow and leak detection service. According to an exemplary embodiment, the integrated flow and leak detection service includes a detection circuit or a signal chain (referred to herein as simply a detection circuit) that performs both flow and leak detection.

According to an exemplary embodiment, the detection circuit may include sensors, a signal generator, a switch, a multiplexer, an amplifier, an analog-to-digital converter (ADC), and a digital signal processor (DSP). According to another exemplary embodiment, the detection circuit may include the sensors, the signal generator, the switch, the amplifier, the ADC, and the DSP. According to still other exemplary embodiments, the detection circuit may not include the sensors.

According to an exemplary embodiment, the sensors may transmit and receive signals that enable measurement of flow information, such as a flow rate, a direction of flow, a flow velocity, a consumption value, as well as receive signals that enable detection of a leak or another type of acoustic anomaly, and localization of the leak or acoustic anomaly relative to the meter. For example, the sensors may be implemented to include ultrasonic transducers. According to another exemplary embodiment, the detection circuit may include a first set of dedicated sensors that provide the flow detection service and a second set of dedicated sensor(s) that provide(s) the leak detection service. For example, the first set of sensors may be implemented to include ultrasonic transducers, and the second sensor(s) may be an ultrasonic transducer or another type of sensor (e.g., acoustic sensor, a hydrophone, a microphone, or the like), which may be implemented as a piezo-electric sensor, a capacitive sensor, an inductive sensor, an optical sensor, a piezo-resistive sensor, or another type of sensor technology, as described herein.

According to an exemplary embodiment, the amplifier of the detection circuit may be configured differently for flow detection relative to leak detection. For example, the amplifier may be implemented as a variable gain amplifier (VGA) or another type of amplifier that may provide a programmable or controllable gain according to the service (e.g., a binary choice between the flow detection service and the leak detection service). The gain or amplification by the amplifier may be further based on various other factors (e.g., type of sensor, sensor characteristics, characteristics of a pipe (e.g., material, diameter, etc.), etc.). Additionally, the gain or amplification may be configured based on other considerations of downstream components (e.g., the ADC) to avoid too large a signal amplitude (e.g., saturation), too small a signal amplitude (e.g., quantization error, etc.), and/or other signal considerations that may lead to less accurate measurements.

According to an exemplary embodiment, the DSP of the detection circuit may perform both flow and leak detection operations. For example, for flow measurement, the DSP may receive signals, store the signals, and apply an algorithm to the stored signals that enable extraction of a time of flight difference between the signals. The DSP may determine a flow rate and other flow information, as described herein. Additionally, the DSP may receive an electrical signal, store the signal, apply an algorithm that analyzes the signal and detects the presence or the absence of a leak or other types of anomalies, as described herein, based on an analysis of the signal. For example, the analysis may include spectrum analysis, as described herein. The analysis may also include spectrum analysis based on other information (e.g., flow rate, pressure, temperature, etc.). The DSP may also use comparisons between the analyzed signals to determine direction associated with leak or acoustic anomaly, distance, and/or location, as described herein.

In view of the foregoing, the integrated flow and leak detection service may enable both flow and leak detection using a cost-effective and optimized detection circuit. For example, in contrast to existing meters, such as water meters, which use separate circuits to measure flow and detect leaks, the integrated flow and leak detection service may provide both flow and leak detection using a unitary or single detection circuit or signal chain.

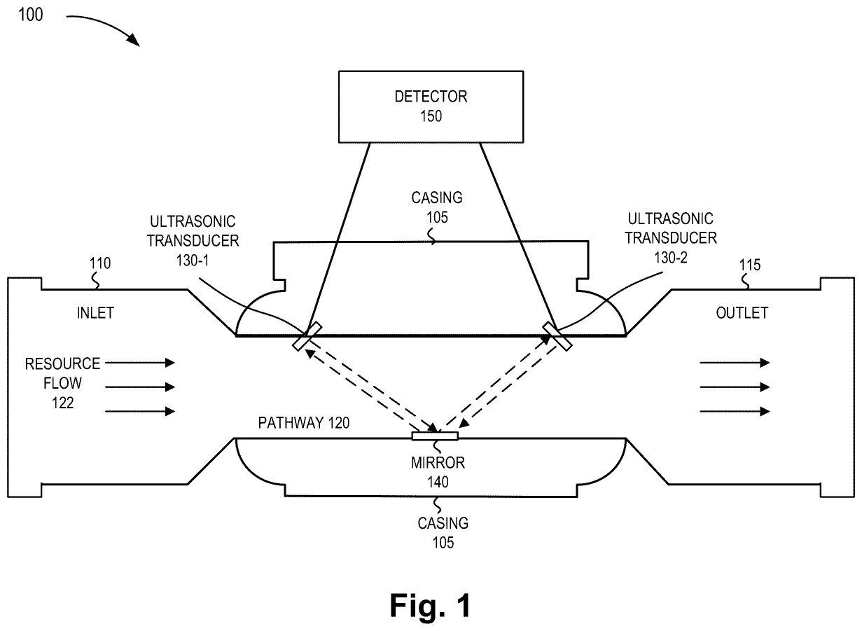

FIG. 1 is a diagram of an exemplary meter 100 that provides an exemplary embodiment of the integrated flow and leak detection service. As illustrated, meter 100 may include a casing 105, an inlet 110, an outlet 115, a pathway 120, ultrasonic transducers 130-1 and 130-2 (also referred to collectively as ultrasonic transducers 130, and generally and individually as ultrasonic transducer 130), a mirror 140, and a detector 150.

Meter 100 may be implemented as a flow meter. For example, meter 100 may be situated in a distribution network and configured to measure the flow of a resource (e.g., water, gas, oil, chemical, or the like), usage or consumption of the resource, and/or the like, and leak detection and localization, as described herein.

Casing 105 may be a housing that encases various elements of meter 100. Inlet 110 and outlet 115 may operate as an input and an output, respectively, relative to a flow of a resource, such as water, for example. A resource flow 122 is depicted as an example of this relative to meter 100. Pathway 120 may provide a passageway between inlet 110 and outlet 115. Inlet 110, outlet 115, and pathway 120 may be implemented as a unitary piece.

Ultrasonic transducer 130 may be a device that converts acoustic signals to electrical signals and vice versa (i.e., electrical signals to acoustic signals). According to some exemplary implementations, ultrasonic transducer 130 may include a piezoelectric transducer or a capacitive transducer, for example. For example, ultrasonic transducer 130-1 may generate and send a pulse or pulses, for example, along a signal path via a resource (e.g., water, etc.) to ultrasonic transducer 130-2, which may receive the pulse or pulses, as described herein and illustrated in FIG. 1. Additionally, for example, ultrasonic transducer 130-2 may generate and send a pulse or pulses, for example, along a signal path via the resource to ultrasonic transducer 130-1, which may receive the pulse or pulses, as described herein and illustrated in FIG. 1. Detector 150 may drive ultrasonic transducers 130 to generate the pulse, pulses, or other type of signal, as described herein. The elapsed time between when the signal is sent from one ultrasonic transducer 130 to another ultrasonic transducer 130, and vice versa, may enable detector 150 to calculate a differential time of flight (TOF). The differential TOF may be used to calculate the velocity of resource flow 122, a flow rate, flow volume, consumption, and the like.

Ultrasonic transducer 130 of meter 100 may be used to also detect a leak, as described herein. For example, one or multiple ultrasonic transducers 130 may be used to listen to acoustic signals (e.g., noise), which may be indicative of the absence or presence of a leak (e.g., in a pipe), and provide the signals to detector 150, as described herein. The number and arrangement of ultrasonic transducers 130 are merely exemplary. For example, according to other exemplary embodiments, the number, configurations, locations, and/or positions of ultrasonic transducers 130 may be different than those illustrated and/or described. For example, while ultrasonic transducers 130 have been illustrated as disposed on a top wall of pathway 120, ultrasonic transducers 130 may be disposed on another wall (e.g., bottom, side, etc.) or radial position associated with pathway 120.

Mirror 140 may be used for flow detection by ultrasonic transducers 130 during normal flow detection. Mirror 140 may be implemented as a steel mirror or another suitable material. Mirror 140 may be flat, concave, or another configuration. According to an exemplary process, meter 100 may use ultrasonic transducers 130 to make flow measurements, as described herein. Additionally, according to an exemplary process, meter 100 may use one or both ultrasonic transducers 130 to detect leaks.

Detector 150 may include logic or components that provide an exemplary embodiment of the integrated flow and leak detection service, as described herein. According to an exemplary embodiment, detector 150 may include a chain of components or elements that provide a flow service and a leak detection service. According to an exemplary embodiment, detector 150 may include sensors (e.g., ultrasonic transducers 130), a signal generator, a switch a multiplexer, a VGA, an ADC, and a DSP, as described herein. According to other exemplary embodiments, detector 150 may include fewer components or elements of a detection circuit. For example, detector 150 may be implemented without the multiplexer.

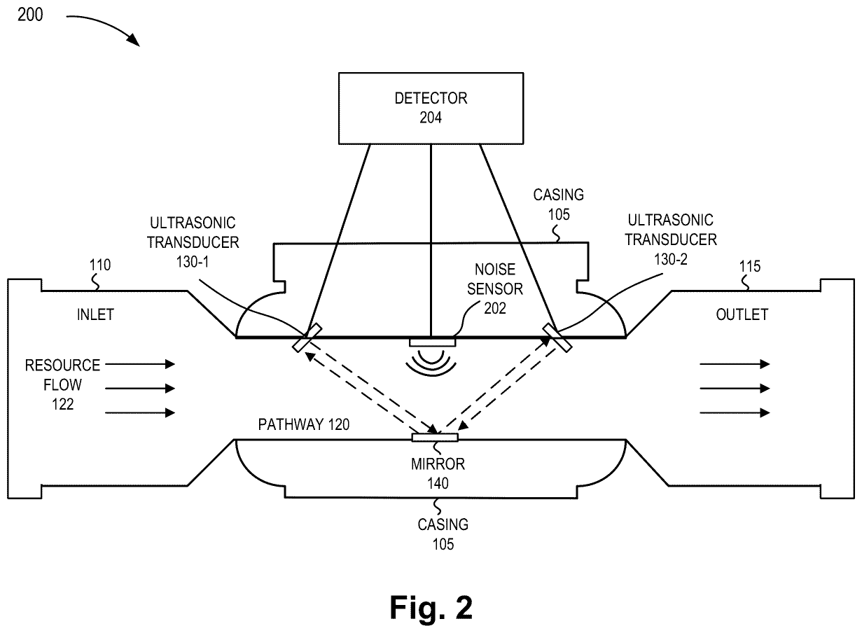

FIG. 2 is a diagram of an exemplary meter 200 that provides an exemplary embodiment of the integrated flow and leak detection service. As illustrated, meter 100 may include casing 105, inlet 110, outlet 115, pathway 120, ultrasonic transducers 130, mirror 140, and detector 150. Additionally, in contrast to meter 100, meter 200 may include a noise sensor 202. That is, in contrast to meter 100 in which ultrasonic transducer 130 may be used for both flow and leak services, meter 200 may include one or multiple noise sensors 202 directed to detecting noise indicative of a leak. As described herein, noise sensor 202 may be a sensor dedicated to detect the noise and may be implemented as an ultrasonic transducer or another type of sensor, as described herein. According to other exemplary embodiments, the number, configurations, locations, and/or positions of ultrasonic transducers 130 and/or noise sensor 202 may be different than those illustrated and/or described.

For purposes of description, although not illustrated in FIGS. 1 and 2, meter 100 and meter 200 may include other components or elements, such as a processor, a controller, or another type of control logic, an MIU, an antenna, a power source (e.g., a battery), and so forth. According to an exemplary embodiment, meter 100 and meter 200 may each be a water meter. According to another exemplary embodiment, meter 100 and/or meter 200 may be another type of meter. According to still another exemplary embodiment, another type of apparatus may include the integrated flow and leak detection service.

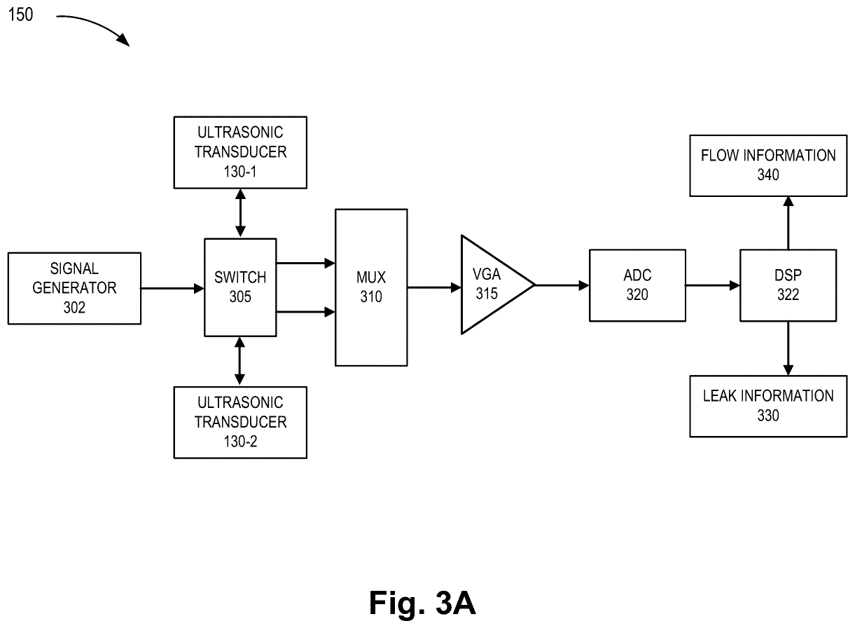

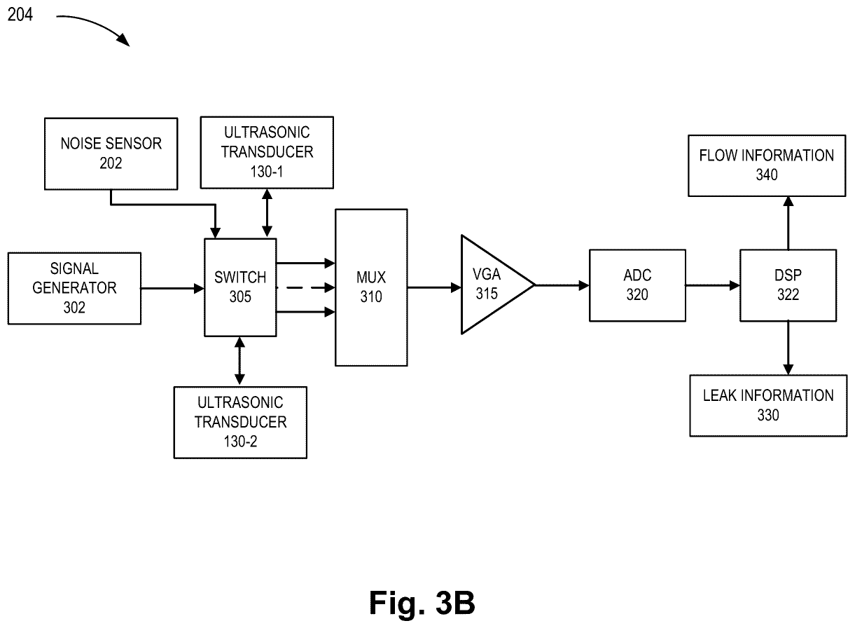

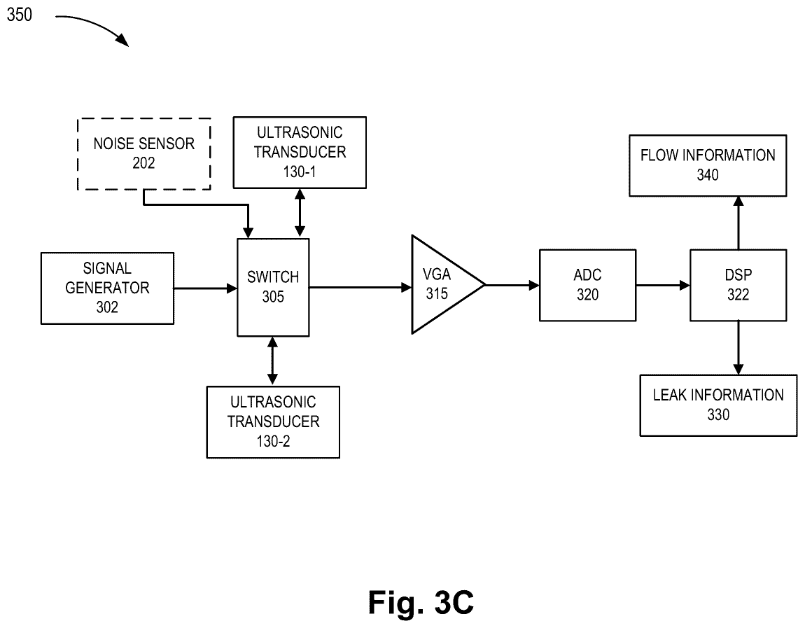

FIG. 3A is a diagram illustrating an exemplary embodiment of detector 150. As illustrated, detector 150 may include ultrasonic transducers 130, a signal generator 302, a switch 305, a MUX 310, a VGA 315, an ADC 320 and a DSP 322. For purposes of description, leak information 330 and flow information 340 are illustrated as outputs of DSP 322. Detector 150 may be implemented as an integrated circuit, a system on chip (SOC), a circuit board, or the like. According to some exemplary embodiments, ultrasonic transducers 130 may not be considered a part of detector 150 but may connect to the sensors, such as ultrasonic transducers 130. The number of inputs to switch 305 and output to switch 305 are exemplary, and may depend on the number of ultrasonic transducers 130, as described herein. Correspondingly, the number of inputs to MUX 310 may depend on the number of outputs of switch 305.

Ultrasonic transducers 130 has been previously described. Signal generator 302 includes a component that generates a signal and transmits the signal to or drives ultrasonic transducer 130 via switch 305. Signal generator 302 may be configured in relation to the type of the signal (e.g., a pulse, a sine wave, a square wave, or another type of signal form), the number of signals, frequency of the signal, gain, damping, and so forth.

Switch 305 may include a component, such as an electronic switch that provides a connection between components based on the service. For example, for flow rate measurement, switch 305 may operate and connect signal generator 302 to ultrasonic transducer 130 and connect ultrasonic transducer 130 to DSP 322 via other components illustrated. For leak detection, signal generator 302 may not be used, and switch 305 may connect ultrasonic transducer 130 to DSP 322 via other components illustrated. According to some embodiments, switch 305 may be implemented to include an electronic switch, such as tristate output buffers (e.g., CMOS transistor gate), diodes, transistors, or another type of control mechanism for switching based on the service and components involved.

MUX 310 may include a component that may include multiple inputs and a common output. For example, MUX 310 may receive signal(s) via the inputs (e.g., simultaneously, different signals via different inputs at different times, etc.) and may connect the signal(s) to the common output and an input of VGA 315.

VGA 315 may include a component, such as an electronic amplifier that has a controllable or programmable gain. For example, VGA 315 may be voltage controlled or digitally controlled (e.g., a digital code or bits). VGA 315 may be configured to have a different gain for signals depending on the service provided. For example, VGA 315 may provide a greater gain for leak detection than for flow measurement. According to some exemplary embodiments, VGA 315 may be implemented as a low noise VGA. VGA 315 may receive a signal from MUX 310, provide a gain, and output the gained signal to an input of ADC 320.

ADC 320 may include a component that may convert an analog signal to a digital signal based on sampling. ADC 320 may include signal conditioning, such as filtering and gain control, for example.

DSP 322 may include a component that may calculate a time-of-flight (TOF) based on signals exchanged between ultrasonic transducers 130. For example, DSP 322 may calculate a differential TOF between the signals (e.g., pulses) associated with ultrasonic transducers 130. DSP 322 may calculate a flow rate of the medium (e.g., water, etc.) based on the differential TOF. DSP 322 may calculate other values, such as flow velocity and/or a consumption value, for example. DSP 322 may include an algorithm or processing logic that calculates the flow rate and other flow and/or consumption values. DSP 322 may include a clock as a time referent. DSP 322 may be configured to sample the signals at a higher rate relative to the leak detection service given the disparity between the ultrasonic frequency range and frequency noise range associated with a leak or another type of acoustic anomaly, as described herein. DSP 322 may output flow information 340. For example, DSP 322 may provide flow information 340 to an MIU (not illustrated) of meter 100 or meter 200. The MIU may transmit flow information 340 to a backend device via a network (e.g., a wireless network). Additionally, or alternatively, DSP 322 may store flow information 340 in a memory, for example.

DSP 322 may further include a component that may detect the presence or the absence of a leak or another type of an anomaly (e.g., noise other than a leak, such as noise produced by other sources (e.g., heating system, cooling system, trains, nearby construction, etc.) based on an acoustic signal detected by ultrasonic transducer 130. DSP 322 may also determine a localization of the leak or other type of acoustic anomaly. DSP 322 may include an algorithm or processing logic that performs spectrum analysis. For example, the spectrum analysis may include analysis related to one or multiple characteristics of the signal, such as frequency, amplitude, power, phase, and/or other characteristics of the acoustic signal. DSP 322 may analyze or evaluate the signal based on other values, such a flow measurement value (e.g., flow rate, etc.), temperature, and/or other context information that may be obtained. DSP 322 may further determine a location and/or direction of the leak or other type of acoustic anomaly (e.g., relative to the meter). For example, when multiple sensors are used to detect the leak, variation between each respective signal may form a basis in determining the location and/or the direction of the leak, among other features associated with the leak, as described herein. DSP 322 may store a threshold value and/or other types of instances of data for comparison to determine the presence or the absence of the leak or another anomaly. DSP 322 may also invoke a remedial procedure when the presence of the leak is detected. For example, the meter may generate and transmit a warning signal or another type of notification to a backend system of the distribution network.

According to some exemplary embodiments, DSP 322 may communicate with an external device (e.g., an application server) via the MIU of meter 100 or meter 200 and a network (e.g., a wireless network). Although not illustrated, the external device may further analyze leak information 330 generated by DSP 322 based on statistical models, machine learning, artificial intelligence (AI), and/or another type of analytics. The external device may be configured to compare, evaluate, and/or compile leak information 330 associated with meter 100 or meter 200 with leak information associated with other meters. The external device may generate analytic information pertaining to leak detection and localization based on the evaluated leak information of meters. For example, the external device may generate, update, modify, validate, etc., threshold acoustic values and/or spectral characteristics (e.g., frequency, amplitude, envelope, power, density, phase, etc., within a bandwidth of interest, etc.) related to noise indicative of the presence or the absence of a leak or another anomaly. The external device may also generate, update, modify, validate, etc., the acoustic values and/or spectral characteristics in relation to different flow rates, temperatures, pressures, conduit or pipe material, diameter of pipe, leak type (e.g., circumferential crack (e.g., in a pipe or another element of a distribution system), longitudinal crack (e.g., in a pipe or another element of a distribution system), valve leak, etc.) and/or other types of factors. The external device may also further evaluate position and time information associated with the leak information obtained from meters situated in a given area.

Leak information 330 may include acoustic values and/or spectral characteristics related to noise indicative of the presence or the absence of a leak or another anomaly, as described herein. Leak information 330 may include position data of meter 100 or meter 200. For example, the position data may include a Global Positioning System (GPS) coordinate (e.g., latitude, longitude), state, city, zip code, and street address, or the like. Leak information 330 may include timestamp data indicating a date (e.g., month, day, and year) and a time period (e.g., 4:30 pm-4:45 pm) or a time (e.g., 4:30 pm).

Flow information 340 may include data that indicates a flow rate of a medium (e.g., water, etc.) going through meter 100 or meter 200. Flow information 340 may include a flow velocity value, a flow volume value, and/or a resource consumption value (e.g., water consumption, oil consumption, etc.).

Referring to FIG. 3A, according to an exemplary process for flow measurement, switch 305 may connect ultrasonic transducer 130-1 to signal generator 302 and connect ultrasonic transducer 130-2 to DSP 322 via MUX 310, VGA 315, and ADC 320. Additionally, during a different period of time, switch 305 may connect ultrasonic transducer 130-2 to signal generator 302 and connect ultrasonic transducer 130-1 to DSP 322 via MUX 310, VGA 315, and ADC 320. The bi-directional arrows between ultrasonic transducers 130 and switch 305 are representative of this sub-process. The electrical signals produced by each ultrasonic transducer 130 may traverse switch 305 and MUX 310 at different times. According to such an exemplary embodiment, while MUX 310 may not receive the electrical signals (substantially) simultaneously and may not be needed to multiplex the electrical signals on its output to VGA 315 due to the time differences, MUX 310 may support the flow measurement service and further support the leak detection service in which switch 305 may receive electrical signals from ultrasonic transducers 130 in a substantially simultaneous manner. As such, this portion of components of detector 150 may provide a common signal chain that supports both the flow measurement service and the leak detection service, as described herein. However, according to other exemplary embodiments, as described in relation to FIG. 3C below, MUX 310 may be omitted from the signal chain of the detector.

According to an exemplary process for leak detection, switch 305 may not connect ultrasonic transducer 130 to signal generator 302. According to various exemplary embodiments, switch 305 may connect to one or both of ultrasonic transducers 130 for leak detection. When switch 305 may connect to both ultrasonic transducers 130, MUX 310 may simultaneously receive electrical signals and multiplex the electrical signals to its output to VGA 315.

According to an exemplary embodiment, detector 150 may toggle between the flow measurement service and the leak detection service, such as non-overlapping time periods. According to some exemplary embodiments, the toggling may be time-based or scheduled (e.g., periodic). According to other exemplary embodiments, the toggling may be non-periodic. For example, detector 150 may be triggered to provide the leak detection service in response to evaluated values of the flow measurement service. For example, when the flow rate is low, near zero, or zero, the controller may invoke the leak detection service. Additionally, or alternatively, the leak detection service may be triggered when flow rates other than low, near zero, or zero are detected. In this regard, the leak detection service may collect noise samples that correlate to different flow rates, as described herein.

According to an exemplary embodiment, VGA 315 may have different gains depending on the service. For example, VGA 315 may have a higher gain output for electrical signals associated with leak detection compared to flow measurement. As such, VGA 315 may be configured within the signal chain of detector 150 in a manner that supports both the flow measurement service and the leak detection service, as described herein. ADC 320 may provide analog-to-digital conversion for both the flow measurement and the leak detection service. According to some exemplary embodiments, ADC 320 may provide different signal conditioning measures depending on the service provided.

According to an exemplary embodiment, DSP 322 may analyze the electrical signals differently depending on the service provided. For example, as described herein, DSP 322 may select the algorithm or processing logic that may calculate TOF and other values relating to flow measurement, as described herein. Contrastingly, DSP 322 may select the algorithm or processing logic that may detect the presence or the absence of a leak or other type of anomaly and determine the localization of the leak or other type of acoustic anomaly, as described herein. According to some exemplary embodiments, electrical signals detected simultaneously by ultrasonic transducers 130 may enable DSP 322 to deduce or estimate a direction (relative to meter 100) of the leak or other acoustic anomaly. This may be useful in the context of district meters and point-of-use meters. DSP 322 may further include sampling the signals associated with flow measurement at a higher rate than the signals directed to leak detection, as described herein.

FIG. 3B is a diagram illustrating an exemplary embodiment of detector 204. As illustrated, detector 204 may include ultrasonic transducers 130, signal generator 302, switch 305, MUX 310, VGA 315, ADC 320 and DSP 322, which have already been described. In contrast to detector 150, detector 204 may include a noise sensor 202. Noise sensor 202 may be a dedicated sensor that may detect acoustic signals (e.g., noise) and may be implemented as an ultrasonic transducer (e.g., ultrasonic transducer 130) or another type of sensor, such as a microphone, a capacitive sensor, an inductive sensor, an optical sensor, a piezo-resistive sensor, a piezo-resistive strain gauge, or another type of acoustic emission sensor. Noise sensor 202 may have a sensitivity to frequencies indicative of the frequency spectrum of acoustic emissions associated with a leak or another type of anomaly, as described herein. For example, the frequency spectrum of noise indicative of the leak is below the ultrasonic frequency range for flow measurement. In this regard, noise sensor 202 may provide data that more accurately represents the acoustic emission indicative of the presence or the absence of the leak or another type of anomaly, as described herein. The number of noise sensor 202 is exemplary and according to other exemplary embodiments, detector 204 may include multiple noise sensors 202 of the same or different types, as described herein.

Referring to FIG. 3B, according to an exemplary process for flow measurement, switch 305 may connect ultrasonic transducer 130-1 to signal generator 302 and connect ultrasonic transducer 130-2 to DSP 322 via MUX 310, VGA 315, and ADC 320. Additionally, during a different period of time, switch 305 may connect ultrasonic transducer 130-2 to signal generator 302 and connect ultrasonic transducer 130-1 to DSP 322 via MUX 310, VGA 315, and ADC 320. In contrast to the process described in relation to FIG. 3A, according to an exemplary embodiment, when the leak detection service is provided, switch 305 may not connect ultrasonic transducers 130 to signal generator 302 and may connect noise sensor 202 to MUX 310. According to other exemplary embodiments, switch 305 may not connect ultrasonic transducers 130 to signal generator 302, but may connect noise sensor 202 and optionally one or both ultrasonic transducers 130 to MUX 310 (where the dotted arrow output from switch 305 to MUX 310 may represent when noise sensor 202 and both ultrasonic transducers are utilized). MUX 310, VGA 315, ADC 320, and DSP 322 may process the signals in a manner similar to that described in relation to the process explained in relation to FIG. 3A, depending on the service provided by the signal chain of detector 204. According to some exemplary embodiments, both services may be provided simultaneously. For example, noise sensor 202 may listen for a leak, and transducers 130 may provide signals for flow measurement. The multiplexed signals may be processed differently by downstream components according to the respective services based on the order of signals in the interleaving. For example, VGA 315 may provide different gains and DSP 322 may provide leak and flow measurement.

FIG. 3C is a diagram illustrating an exemplary embodiment of a detector 350. As illustrated, detector 350 may include ultrasonic transducers 130, signal generator 302, switch 305, VGA 315, ADC 320 and DSP 322, which have already been described. In contrast to detector 150, detector 350 may omit MUX 310 and noise sensor 202. Additionally, in contrast to detector 204, detector 350 may omit MUX 310. Detector 350 may be implemented with meter 100 or meter 200, for example.

Referring to FIG. 3C, according to an exemplary process for flow measurement, switch 305 may connect ultrasonic transducer 130-1 to signal generator 302 and connect ultrasonic transducer 130-2 to DSP 322 via MUX 310, VGA 315, and ADC 320. Additionally, during a different period of time, switch 305 may connect ultrasonic transducer 130-2 to signal generator 302 and connect ultrasonic transducer 130-1 to DSP 322 via MUX 310, VGA 315, and ADC 320. In contrast to an exemplary embodiment of the process described in relation to FIG. 3A, switch 305 may connect to a single transducer 130 or both ultrasonic transducers 130, but during non-overlapping time periods for leak detection. According to such an exemplary embodiment, MUX 310 may be omitted.

According to another exemplary embodiment, when noise sensor 302 is included, switch 305 may connect each ultrasonic transducer 130 to signal generator 302 during non-overlapping time periods associated with flow measurement, and switch 305 may connect noise sensor 202 or noise sensor 202 and one or both ultrasonic transducers 130 to VGA 315 during non-overlapping time periods. Consequently, MUX 310 may be omitted. VGA 315, ADC 320, and DSP 322 may process the signals in a manner similar to that described in relation to the process explained in relation to FIG. 3A, depending on the service provided by the signal chain of detector 350.

Although FIGS. 3A-3C illustrate exemplary components of an exemplary embodiment of a detector, such as detector 150, detector 204, and detector 350, meter 100 and meter 200 may each include other components that may be coupled to the detector (e.g., connected to one or multiple components of the detector). For example, meter 100 and/or meter 200 may include an MIU, a controller, a temperature sensor, a power source, a memory, and/or other elements or devices, as described herein.

For the sake of description, the MIU may transmit and receive messages via a wireless network, such as a Long Range wide area network (LoRaWAN), a Sigfox low-power WAN (LPWAN), an Ingenu machine network, an Evolved UMTS Terrestrial Radio Access Network (E-UTRAN) (e.g., a Fourth Generation radio access network (4G RAN)), a 4.5G RAN, a next generation RAN (e.g., a 5G-access network), a future generation RAN (e.g., a 6G RAN, a public land mobile network (PLMN), a Worldwide Interoperability for Microwave Access (WiMAX) network, a mobile transceiver network (e.g., a mobile or handheld user device (e.g., operated by a user or a technician associated with a utility company, such as a water company), a vehicle mounted device, or another suitable mobile device (e.g., a drone, etc.)), a proprietary wireless network (e.g., owned and operated by a utility company (e.g., a water utility company, etc.), a wireless network that supports an AMR, system, an AMI system, an AMS, etc.), a Wi-Fi network, and/or other types of wireless networks (e.g., Bluetooth, etc.). The MIU may also transmit and receive messages via a wired connection. For example, the technician may interface with the meter via the MIU via a cable or other form of connector. The MIU may be integrated with the meter or provided as a separate device from the meter, but communicatively coupled with the meter.

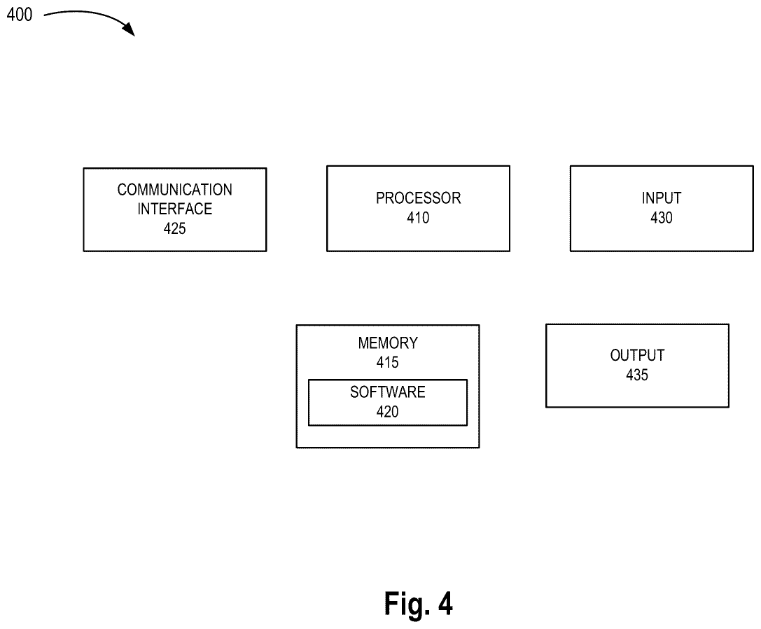

The controller may include a processor and/or logic circuitry that executes one or more processes/functions. The controller may include ports for receiving and sending data, including sending control instructions and receiving control acknowledgements, from a components of detector 150. The controller may also communicate with other components (e.g., the MIU, etc.) of meter 100 and meter 200. Components of the MIU and the controller, as well as other components of the meter are further described and illustrated in FIG. 4.

FIG. 4 is a diagram illustrating exemplary components that may be included in a meter, such as flow meter, as described herein. For example, one or more of the components may be included in the detector, components external from the detector, such as the MIU and the controller, or external from the meter but communicatively coupled to the meter (e.g., the MIU). As illustrated in FIG. 4, the components may include a processor 410, a memory 415, and a communication interface 425. According to some exemplary embodiments, memory 415 may store software 420, as illustrated in FIG. 4. According to other embodiments, fewer components, additional components, and/or different components than those illustrated in FIG. 4 and described herein, may be implemented.

Processor 410 includes one or multiple processors, microprocessors, microcontrollers, application specific integrated circuits (ASICs), programmable logic devices, chipsets, field-programmable gate arrays (FPGAs), application specific instruction-set processors (ASIPs), system-on-chips (SoCs), central processing units (CPUs) (e.g., one or multiple cores), and/or some other type of component that interprets and/or executes instructions and/or data. Processor 410 may be implemented as hardware (e.g., a microprocessor, etc.), a combination of hardware and software (e.g., a SoC, an ASIC, etc.), may include one or multiple memories (e.g., cache, etc.), etc. By way of example, DSP 322, the MIU, and the controller may each include processor 410 or a same processor 410 may be used (e.g., shared) by two or more of these components.

Memory 415 includes one or multiple memories and/or one or multiple other types of storage mediums. For example, memory/storage 415 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM). By way of example, DSP 322, the MIU, and the controller may each include memory 415 or shared by two or more of these components. Memory 415 may store data and/or software 420, for example.

Software 420 includes an application or a program that provides a function and/or a process. As an example, with reference to DSP 322 and/or the controller, software 420 may include an application that, when executed by processor 410, provides a function and/or a process of the integrated flow and leak detection service, as described herein. Software 420 may include software, firmware, middleware, microcode, hardware description language (HDL), and/or another form of instruction.

Communication interface 425 permits the meter to communicate with other devices, networks, systems, and/or the like. Communication interface 425 may include a wireless interface, an optical interface, and/or a wired interface. For example, communication interface 425 may include one or multiple transmitters and receivers, or transceivers. Communication interface 425 may operate according to a protocol stack and a communication standard. Communication interface 425 may support one or multiple transmission/reception configurations. The MIU may include communication interface 425, for example.

The meter may be configured to perform a process and/or a function, as described herein, in response to processor 410 executing software 420 stored by memory 415. For example, the instructions stored by memory 415 cause processor 410 to perform a function or a process described herein. According to some exemplary embodiments, instructions may be read into memory 415 via communication interface 425. For example, the meter may receive instructions from a backend device associated with a flow distribution network. Alternatively, for example, according to other implementations, the meter may be configured to perform a function or a process described herein based on the execution of hardware (processor 410, etc.).

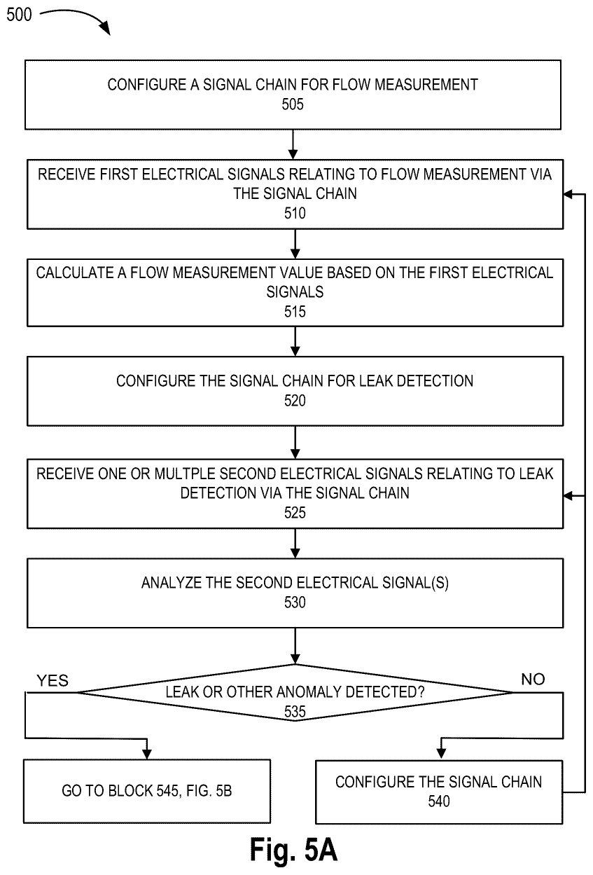

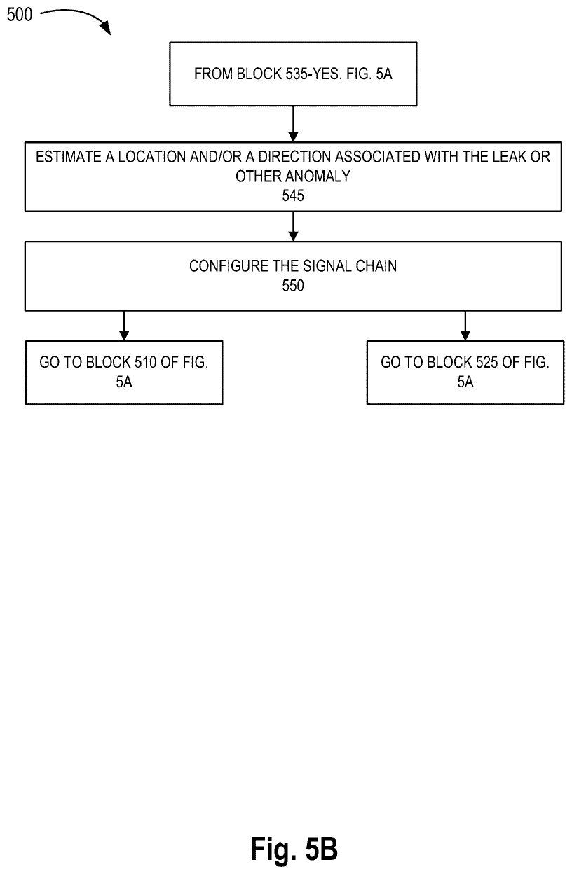

FIGS. 5A and 5B are flow diagrams illustrating an exemplary process 500 of an exemplary embodiment of the integrated flow and leak detection service. According to an exemplary embodiment, meter 100 or meter 200 may perform steps of process 500. According to an exemplary implementation, a detector, such as detector circuits 150, 204, and/or 350 may perform, in whole or in part, process 500. According to an exemplary implementation, processor 410 may execute software to perform one or more steps illustrated and described in relation to FIG. 5. Alternatively, a step illustrated in FIGS. 5A and 5B, and described herein, may be performed by execution of only hardware. For purposes of description, process 500 is described as performed by the detector.

Referring to FIG. 5A, in block 505, the detector may be configured to a flow measurement configuration. For example, the signal chain of the detector may be configured to provide the flow measurement service, as described herein.

In block 510, the detector may receive first electrical signals relating to flow measurement via the signal chain of the detector. For example, the detector may receive signals from sensors, such as ultrasonic transducers. The signals may be received by a DSP via other components of the signal chain of the detector, as described herein.

In block 515, the detector may calculate a flow measurement value based on the first electrical signals. For example, the DSP may calculate a differential TOF, a flow rate, a consumption of a resource, and/or other values (e.g., flow volume, velocity of the resource, etc.), as described herein. According to some exemplary embodiments, one or multiple flow measurement values may be output to an MIU for transmission to a backend system via a network, as described herein. According to other exemplary embodiments, one or multiple flow measurement values may be (temporarily) stored, and output to the MIU for transmission according to a schedule, for example.

In block 520, the detector may be configured to a leak detection configuration. For example, the signal chain of the detector may be configured to provide the leak detection service, as described herein.

In block 525, the detector may receive one or multiple second electrical signals relating to leak detection via the signal chain. For example, the detector may receive signals from a sensor(s), such as the ultrasonic transducer(s), a noise sensor, or both.

In block 530, the detector may analyze the second electrical signal(s). For example, the detector may determine the presence or the absence of a leak or another type of anomaly. For example, the DSP may perform spectrum analysis of the second electrical signal(s). The DSP may perform the spectrum analysis in view of other information (e.g., flow rate, temperature, pressure, etc.), as described herein.

When the detector determines that a leak or other anomaly is not detected (block 535-NO), the detector may be configured (block 540). For example, the detector may be configured to the flow measurement configuration or the leak detection configuration. According to an exemplary embodiment, in view of blocks 520-535, the configuration of the signal chain to a leak detection configuration may be performed by inaction. For example, the signal chain may currently be in the leak detection configuration and may not be reconfigured. When the signal chain is configured to the flow measurement configuration, block 540 may include the reconfiguration of the signal chain to provide the flow measurement service, as described herein. Process 500 may continue to block 510 or block 525 depending on the determined configuration.

When the detector determines that a leak or other anomaly is detected (block 535-YES), the detector may estimate a location and/or a direction associated with the leak or other anomaly (block 545 of FIG. 5B). For example, the DSP may estimate the direction and/or distance of the leak or other anomaly (e.g., relative to the meter) based on differences in the spectrum analyses between the second electrical signals.

In block 550, the detector may be configured. For example, the detector may be configured to operate in a flow measurement configuration or a leak detection configuration in a manner similar to that described in relation to block 540. Depending on the configuration, process 500 may continue to block 510 of FIG. 5A or block 525 of FIG. 5A.

FIGS. 5A and 5B illustrate an exemplary process 500 of the integrated flow and leak detection service, however, according to other embodiments, process 500 may include additional operations, fewer operations, and/or different operations than those illustrated in FIGS. 5A and 5B and described herein. For example, the detector may receive a control signal from the controller that may cause the detector to reconfigure in a particular mode of operation (e.g., leak detection to flow measurement, or vice versa). Additionally, as described herein, process 500 may include flow information and/or leak information transmitted to an external device via the MIU, as described herein. Process 500 may further include processes described in relation to leak detection performed by an external device (e.g., an application server), as described herein.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

Embodiments described herein may be implemented in many different forms of hardware or software executed by hardware. For example, a process, a function, a step of a process or the like, in whole or in part, may be implemented as “logic,” a “component,” an “element,” a “circuit” (e.g., digital, analog, integrated, or combination) (referred to as “hardware”). The hardware may include, for example, processor 410, ultrasonic transducer 130, noise sensor 202, signal generator 302, switch 305, MUX 310, VGA 315, ADC 320, DSP 322, and/or other types of hardware, as described herein, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Spatially relative terms, such as “beneath,” “below,” “lower,” “above,” “upper,” “top”, “bottom” and the like, may be used herein for ease of description to describe one element's or feature's relationship to another element or feature as illustrated in the figures. The spatially relative terms are intended to encompass different orientations of the device in use or operation, in addition to the use or the operation depicted in the figures. For example, if the device in the figure is turned over, an element described as “below” or “beneath” another element or another feature would then be oriented “above” the other element or the other feature. Thus, the exemplary terms “below” or “beneath” may encompass both an orientation of above and below depending on the orientation of the device. In the instance that the device may be oriented in a different manner (e.g., rotated at 90 degrees or at some other orientation), the spatially relative terms used herein should be interpreted accordingly.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated. The term “substantially” is used herein to represent the inherent degree of uncertainty that may be attributed to any quantitative comparison, value, measurement, or other representation. The term “substantially” is also used herein to represent the degree by which a quantitative representation may vary from a stated reference without resulting in a change in the basic function of the subject matter at issue.

Additionally, embodiments described herein may be implemented as a non-transitory computer-readable storage medium that stores data and/or information, such as instructions, software, firmware, microcode, source code, object code, program code, a data structure, a program module, an application, a script, or other known or conventional form suitable for use in a computing environment. The program code, instructions, application, etc., is readable and executable by a processor (e.g., processor 410) of a device, such as a meter or another type of apparatus.

All structural and functional equivalents to the elements of the various aspects set forth in this disclosure that are known or later come to be known to those of ordinary skill in the art are expressly incorporated herein by reference and are intended to be encompassed by the claims.

What is claimed is:

1. A meter comprising:
an inlet;
an outlet;
a passageway between the inlet and the outlet;
sensors; and
a detector circuit, wherein the detector circuit includes a signal chain that operates in a leak detection configuration, which includes detection of a presence or an absence of a leak, and a flow measurement configuration, which includes calculation of a flow measurement value, and wherein the detector circuit is configured to receive first electrical signals from the sensors relating to flow measurement when operating in the flow measurement configuration, and configured to receive one or more second electrical signals from one or more of the sensors when operating in the leak detection configuration.

2. The meter of claim 1, wherein the signal chain includes a switch, a variable gain amplifier, an analog-to-digital converter, and a digital signal processor.

3. The meter of claim 2, wherein the signal chain further includes a multiplexer.

4. The meter of claim 2, wherein the signal chain further includes a signal generator, and wherein the switch provides a connection between one of the sensors and the signal generator when operating in the flow measurement configuration, and does not provide the connection when operating in the leak detection configuration.

5. The meter of claim 2, wherein the variable gain amplifier provides a first gain relative to the first electrical signals when operating in the flow measurement configuration, and provides a second gain, which differs from the first gain, relative to the one or more second electrical signals when operating in the leak detection configuration.

6. The meter of claim 2, wherein the digital signal processor is configured to calculate the flow measurement value, wherein the flow measurement value includes a flow rate associated with a resource and one or more of a consumption value or a flow velocity value.

7. The meter of claim 2, wherein the digital signal processor is configured to perform spectrum analysis on the one or more second electrical signals.

8. The meter of claim 1, wherein the signal chain changes from the leak detection configuration to the flow measurement configuration and vice versa in response to a control signal.

9. The meter of claim 1, wherein the meter is a water meter.

10. The meter of claim 1, wherein the sensors include ultrasonic transducers.

11. A method comprising:
receiving, by a meter including an inlet, an outlet, and a passageway between the inlet and the outlet, sensors, and a detector circuit that includes a signal chain that operates in a leak detection configuration and a flow measurement configuration, a resource;
detecting, by the meter, a presence or an absence of a leak when the signal chain operates in the leak detection configuration; and
calculating, by the meter, a flow measurement value when the signal chain operates in the flow measurement configuration, wherein the detector circuit is configured to receive first electrical signals from the sensors relating to flow measurement when operating in the flow measurement configuration, and configured to receive one or more second electrical signals from one or more of the sensors when operating in the leak detection configuration.

12. The method of claim 11, wherein the signal chain includes a switch, a variable gain amplifier, an analog-to-digital converter, and a digital signal processor.

13. The method of claim 12, wherein the signal chain further includes a multiplexer.

14. The method of claim 12, wherein the calculating of the flow measurement value comprises:
calculating, by the digital signal processor, a flow rate value and one or more of a consumption value or a flow velocity value.

15. The method of claim 12, wherein the detecting of the presence or the absence of the leak comprises:
performing, by the digital signal processor, spectrum analysis on the one or more second electrical signals.

16. The method of claim 12, wherein the variable gain amplifier provides a first gain relative to the first electrical signals when operating in the flow measurement configuration, and provides a second gain, which differs from the first gain, relative to the one or more second electrical signals when operating in the leak detection configuration.

17. The method of claim 11, wherein the signal chain changes from the leak detection configuration to the flow measurement configuration and vice versa in response to a control signal.

18. The method of claim 11, wherein the meter is a water meter and the resource is water.

19. The method of claim 11, wherein the sensors include ultrasonic transducers.

20. An apparatus comprising:
an inlet;
an outlet;
a passageway between the inlet and the outlet;
sensors; and
a detector circuit, wherein the detector circuit includes a signal chain that operates in a leak detection configuration, which includes detection of a presence or an absence of a leak, and a flow measurement configuration, which includes calculation of a flow measurement value, and wherein the detector circuit is configured to receive first electrical signals from the sensors relating to flow measurement when operating in the flow measurement configuration, and configured to receive one or more second electrical signals from one or more of the sensors when operating in the leak detection configuration.
